(19) United States
(12) Patent Application Publication
(10) Pub. No.: US 2026/0085160 A1
(43) Pub. Date: Mar. 26, 2026

(54) HYDROXYL POLYMER MATERIAL, MANUFACTURING METHOD THEREOF, AND STRUCTURAL COMPONENT COMPOSED THEREBY

(71) Applicant: ASUSTEK COMPUTER INC., TAIPEI (TW)

(72) Inventors: Yu-Chun YANG, TAIPEI (TW); Po-Wen HUANG, TAIPEI (TW); Guo-Lin YANG, TAIPEI (TW); Er-Bao NIU, TAIPEI (TW); Tao CHEN, TAIPEI (TW)

(21) Appl. No.: 18/965,322

(22) Filed: Dec. 2, 2024

(30) Foreign Application Priority Data
Sep. 20, 2024 (TW) 113135713

(51) Int. Cl. C08J 3/20; C08J 5/04

(52) U.S. Cl. CPC C08J 3/203; C08J 5/043; C08J 2300/104

(57) ABSTRACT

A method for manufacturing a hydroxyl polymer material is provided. First, a hydroxyl resin modified material is prepared. Subsequently, a liquid with an organic polymer, silicon carbide, and aluminum oxide as a first auxiliary material added thereto is prepared. Then, an acrylic mixed reaction resin material with silica, diamond powder, a ceramic particle material, and glass fiber powder as a second auxiliary material added thereto is prepared. Next, the hydroxyl resin modified material, the liquid, and the acrylic mixed reaction resin material are mixed uniformly to obtain a hydroxyl mixed reaction resin material. Then, the hydroxyl mixed reaction resin material and an acrylic compound resin material are mixed uniformly to obtain the hydroxyl polymer material. The hydroxyl polymer material and a structural component composed thereby are also provided.

### CROSS-REFERENCE TO RELATED APPLICATION

This application claims the priority benefit of Taiwan Application Serial No. 113135713, filed on Sep. 20, 2024. The entirety of the above-mentioned patent application is hereby incorporated by reference herein and made a part of specification.

### BACKGROUND OF THE INVENTION

### Field of the Invention

The disclosure relates to a hydroxyl polymer material, a manufacturing method thereof, and a structural component composed thereby.

### Description of the Related Art

Hydroxyl polymer materials are commonly used in the manufacture of housings of electronic devices. A conventional hydroxyl polymer material is obtained through reaction after mixing acrylic resin, a pigment, a curing agent, a thinner, an adjuvant, and the like. However, physical properties of the conventional hydroxyl polymer material are not good, and consequently the surface of an object is susceptible to contamination, difficult to clean, and lack of abrasion resistance.

### BRIEF SUMMARY OF THE INVENTION

The disclosure provides a method for manufacturing a hydroxyl polymer material. The manufacturing method includes the following steps. First, a hydroxyl resin modified material is prepared. Subsequently, a liquid with a first auxiliary material added thereto is prepared, where the first auxiliary material includes an organic polymer, silicon carbide, and aluminum oxide. Then, an acrylic mixed reaction resin material with a second auxiliary material added thereto is prepared, where the second auxiliary material includes silica, diamond powder, a ceramic particle material, and glass fiber powder. Next, the hydroxyl resin modified material, the liquid, and the acrylic mixed reaction resin material are mixed uniformly to obtain a hydroxyl mixed reaction resin material. Then, the hydroxyl mixed reaction resin material and an acrylic compound resin material are mixed uniformly to obtain the hydroxyl polymer material.

The disclosure also provides a hydroxyl polymer material. The hydroxyl polymer material includes a hydroxyl resin modified material, a first auxiliary material, a second auxiliary material, and an acrylic compound resin material. The first auxiliary material includes an organic polymer, silicon carbide, and aluminum oxide. The second auxiliary material includes silica, diamond powder, a ceramic particle material, and glass fiber powder.

The disclosure also provides a structural component. The structural component is composed by the hydroxyl polymer material.

A conventional hydroxyl film has poor physical properties, so that its surface is susceptible to contamination, difficult to clean, lack of fingerprint resistance, and lack of abrasion resistance, which easily causes scratches on the surface of an object. In contrast, a hydroxyl film made of the hydroxyl polymer material of the disclosure is not susceptible to contamination, easy to clean, fingerprint resistant, and abrasion resistant, which helps to avoid scratches on the surface of an object.

### BRIEF DESCRIPTION OF THE DRAWINGS

FIG. 1 is a flowchart of a method for manufacturing a hydroxyl polymer material according to an embodiment of the disclosure;

FIG. 2 shows an embodiment of step S110 in FIG. 1;

FIG. 3 shows an embodiment of a procedure of preparing a first auxiliary material;

FIG. 4 shows an embodiment of a procedure of preparing a second auxiliary material;

FIG. 5 shows an embodiment of step S140 in FIG. 1; and

FIG. 6 shows an embodiment of step S150 in FIG. 1.

### DETAILED DESCRIPTION OF THE EMBODIMENTS

The following describes specific embodiments of the disclosure in more detail with reference to the drawings. The advantages and features of the disclosure become clearer according to the following descriptions and the scope of the patent application. It is to be noted that the drawings are in a very simplified form and all in non-precise proportions, and are used only for conveniently and clearly describing the embodiments of the disclosure.

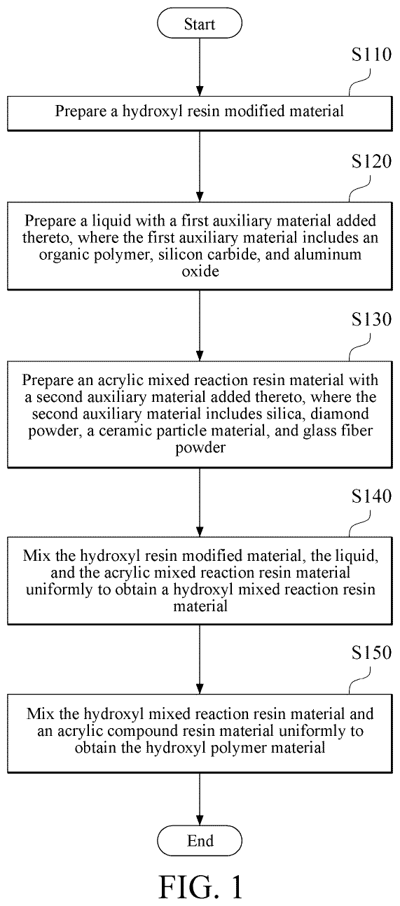

FIG. 1 is a flowchart of a method for manufacturing a hydroxyl polymer material according to an embodiment of the disclosure. The hydroxyl polymer material is suitable for use as a structural component of an electronic device, such as a housing, or use as a surface layer on a structural component.

The disclosure provides a method for manufacturing a hydroxyl polymer material. The manufacturing method includes the following steps.

First, as described in step S110, a hydroxyl resin modified material is prepared. In an embodiment, the hydroxyl resin modified material is a hydroxyl resin abrasion-resistant modified material. The technique for polymer modification is well known in the art and is not the focus of the disclosure. Details are not described herein. However, the disclosure is not limited thereto. In another embodiment, a common hydroxyl resin material is used.

In an embodiment, a proportion of the hydroxyl resin modified material prepared in step S110 is 65-70 wt % of a total weight of the hydroxyl polymer material obtained by the manufacturing method.

Subsequently, as described in step S120, a liquid with a first auxiliary material added thereto is prepared. The first auxiliary material includes an organic polymer, silicon carbide, and aluminum oxide. In an embodiment, the liquid includes a carbide as a main component. In an embodiment, the carbide is an adjuvant for improving corrosion resistance, hardness, or toughness. 3-7 wt % of the organic polymer, 1.7-2.3 wt % of the silicon carbide, and 0.4-0.8 wt % of the aluminum oxide are added to the liquid as the first auxiliary material. Further, in an embodiment, the aluminum oxide is fine-grained aluminum oxide.

Then, as described in step S130, an acrylic mixed reaction resin material is prepared. A second auxiliary material is added to the acrylic mixed reaction resin material. The second auxiliary material includes silica, diamond powder, a ceramic particle material, and glass fiber powder. In an embodiment, the acrylic mixed reaction resin material includes acrylic acid as a main component, and 5-10 wt % of the silica, 1-4 wt % of the diamond powder, 1.5-4.5 wt % of the ceramic particle material, and 0.5-1.5 wt % of the glass fiber powder are added as the second auxiliary material.

Steps S110, S120, and S130 may be adjusted in the sequence according to an actual situation, or may be performed synchronously.

Next, as described in step S140, the hydroxyl resin modified material, the liquid, and the acrylic mixed reaction resin material are mixed uniformly to obtain a hydroxyl mixed reaction resin material.

Then, as described in step S150, the hydroxyl mixed reaction resin material and an acrylic compound resin material are mixed uniformly to obtain the hydroxyl polymer material.

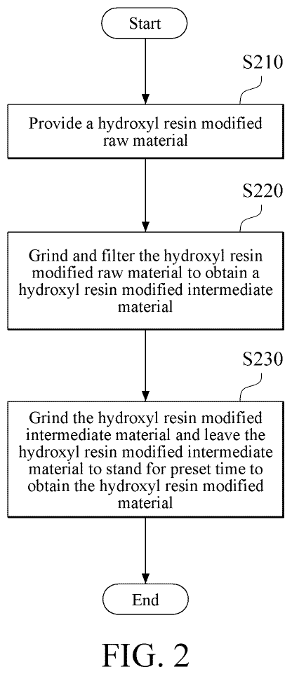

In an embodiment, a proportion of the acrylic compound resin material added in step S150 is 10-15 wt % of the hydroxyl polymer material obtained by the manufacturing method. In other words, the hydroxyl polymer material obtained by the manufacturing method includes 10-15 wt % of the acrylic compound resin material. FIG. 2 shows an embodiment of step S110 in FIG. 1.

First, as described in step S210, a hydroxyl resin modified raw material is provided.

Then, as described in step S220, the hydroxyl resin modified raw material is ground and filtered to obtain a hydroxyl resin modified intermediate material. In an embodiment, in this step, the hydroxyl resin modified raw material is subjected to high-speed grinding for 8 to 12 hours, and then filtered by using a 2000-mesh air gun. The high-speed grinding is carried out at 2000 to 3000 rpm.

Subsequently, as described in step S230, the hydroxyl resin modified intermediate material is ground and left to stand for preset time. In an embodiment, in this step, the hydroxyl resin modified intermediate material is ground at a regular speed for 12 to 24 hours, and then left to stand and settle for 24 hours for use. The regular speed is 1300 to 1800 rpm.

Through steps S210 to S230, the hydroxyl resin modified material with a uniform particle size is provided to ensure the quality of the hydroxyl polymer material obtained in the disclosure.

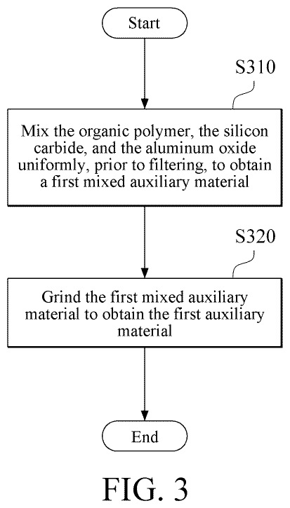

FIG. 3 shows an embodiment of a procedure of preparing a first auxiliary material.

First, as described in step S310, the organic polymer, the silicon carbide, and the aluminum oxide are mixed uniformly and filtered to obtain a first mixed auxiliary material. In this step, the organic polymer, the silicon carbide, and the aluminum oxide are subjected to high-speed grinding for 16 to 18 hours to mix the materials uniformly, and filtered by using a 1500-mesh air gun, to obtain the first mixed auxiliary material. The high-speed grinding is carried out at 2000 to 3000 rpm.

Next, as described in step S320, the first mixed auxiliary material is ground to obtain the first auxiliary material. In an embodiment, in this step, the filtered first mixed auxiliary material is still subjected to high-speed grinding for 16 to 18 hours, and then left to stand and settle for 12 hours for use.

Through steps S310 and S320, the first auxiliary material with a uniform particle size is provided to ensure the quality of the hydroxyl polymer material obtained in the disclosure.

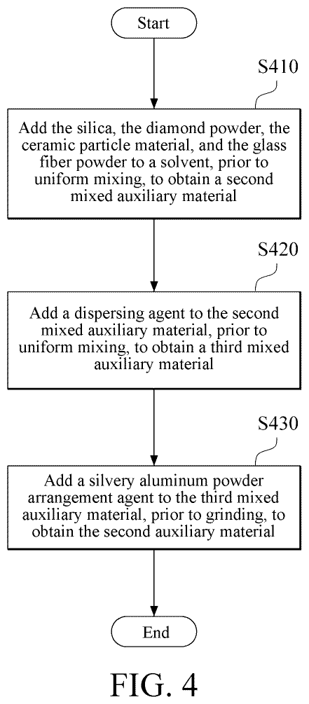

FIG. 4 shows an embodiment of a procedure of preparing a second auxiliary material.

First, as described in step S410, the silica, the diamond powder, the ceramic particle material, and the glass fiber powder are added to a solvent and mixed uniformly to obtain a second mixed auxiliary material. In an embodiment, the solvent is alcohol. In an embodiment, in this step, the silica, the diamond powder, the ceramic particle material, and the glass fiber powder are mixed and immersed in the solvent for 72 hours, and then sealed and shaken for 3 to 6 hours.

Then, as described in step S420, a dispersing agent is added to the second mixed auxiliary material and mixed uniformly to obtain a third mixed auxiliary material. In an embodiment, in this step, the dispersing agent is added and subjected to high-speed grinding for 36 to 48 hours, and then filtered by using a 1000-mesh air gun.

Then, as described in step S430, a silver powder arrangement agent is added to the third mixed auxiliary material and ground to obtain the second auxiliary material. In an embodiment, in this step, the silver powder arrangement agent is added and subjected to high-speed grinding for 36 to 48 hours, and then left to stand and settle for 36 hours for use.

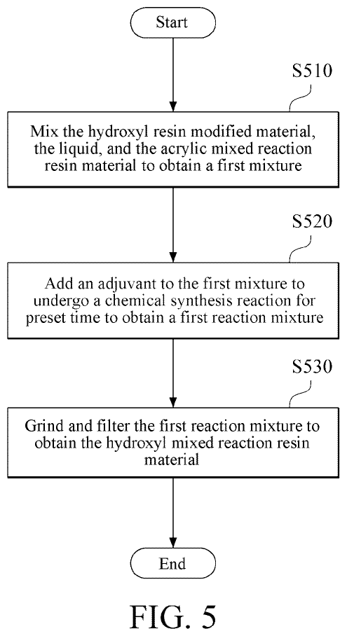

FIG. 5 shows an embodiment of step S140 in FIG. 1.

First, as described in step S510, the hydroxyl resin modified material, the liquid, and the acrylic mixed reaction resin material are mixed to obtain a first mixture. In an embodiment, in this step, the hydroxyl resin modified material, the liquid, and the acrylic mixed reaction resin material are sequentially filtered through 1500 meshes into the same tank, and then sealed and shaken for 2 hours.

Then, as described in step S520, an adjuvant is added to the first mixture to undergo a chemical synthesis reaction for preset time to obtain a first reaction mixture. In an embodiment, in this step, the adjuvant, such as an anti-settling agent and a flatting agent, is added into the tank, and then sealed to undergo a chemical synthesis reaction for 72 hours.

Subsequently, as described in step S530, the first reaction mixture is ground and filtered to obtain the hydroxyl mixed reaction resin material. In an embodiment, in this step, the reaction mixture is subjected to high-speed grinding for 36 to 48 hours, filtered by using a 2000-mesh air gun, subjected to high-speed fine grinding for 36 to 48 hours, and then left to stand and settle for 48 hours for use.

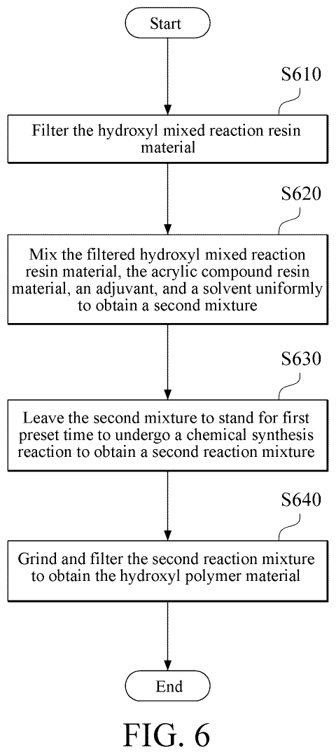

FIG. 6 shows an embodiment of step S150 in FIG. 1.

First, as described in step S610, the hydroxyl mixed reaction resin material is filtered. In an embodiment, in this step, the hydroxyl mixed reaction resin material is filtered out of the tank by 85%-95% by using a 2000-mesh air gun, and 5%-15% of solution is removed from the bottom of the tank.

Subsequently, as described in step S620, the filtered hydroxyl mixed reaction resin material, the acrylic compound resin material, an adjuvant, and a solvent are mixed uniformly to obtain a second mixture. In an embodiment, in this step, the filtered hydroxyl mixed reaction resin material, the acrylic compound resin material, the adjuvant, and the solvent are added into the same tank, and sealed and shaken for 2 to 3 hours.

In an embodiment, the adjuvant added in step S620 includes a curing agent, a flatting agent, an anti-settling agent, a dispersing agent, and a silver powder arrangement agent. In an embodiment, the solvent added in step S620 includes a quick drying thinner, a slow drying thinner, a strong acid thinner, a weak acid thinner, and pure water.

Subsequently, as described in step S630, the second mixture is left to stand for first preset time to undergo a chemical synthesis reaction to obtain a second reaction mixture. In an embodiment, the first preset time is 24 to 38 hours.

Then, as described in step S640, the second reaction mixture is ground and filtered to obtain the hydroxyl polymer material.

In an embodiment, in this step, the reaction mixed intermediate is subjected to low-speed fine grinding for 48 to 60 hours, then left to stand and settle for 12 to 24 hours, and then filtered by using a 2000-mesh air gun, to obtain the hydroxyl polymer material. The low-speed fine grinding is carried out at 800 to 1200 rpm.

In terms of physical performance tests, 200 g of the conventional hydroxyl film is subjected to a wool felt abrasion resistance test, which is less than 8000 times, subjected to an RCA test, which is less than 100 times, subjected to an eraser abrasion resistance test, which is less than 600 times, and subjected to an alcohol abrasion resistance test, which is less than 600 times. 500 g of the hydroxyl film made of the hydroxyl polymer material of the disclosure is subjected to a wool felt abrasion resistance test, which is greater than 100000 times, subjected to an RCA test, which is greater than 300 times, subjected to an eraser abrasion resistance test, which is greater than 10000 times, and subjected to an alcohol abrasion resistance test, which is greater than 10000 times.

A conventional hydroxyl film has poor physical properties, so that its surface is susceptible to contamination, difficult to clean, lack of fingerprint resistance, and lack of abrasion resistance, which easily causes scratches on the surface of an object. In contrast, a hydroxyl film made of the hydroxyl polymer material of the disclosure is not susceptible to contamination, easy to clean, fingerprint resistant, and abrasion resistant, which helps to avoid scratches on the surface of an object.

The foregoing descriptions are merely preferred embodiments of the disclosure, and do not constitute any limitation on the disclosure. Any equivalent replacement or modification in any form made by any person skilled in the art on the technical means and technical content provided in the disclosure without departing from the scope of the technical means of the disclosure is not out of the content of the technical means of the disclosure, and falls within the protection scope of the disclosure.

What is claimed is:

1. A method for manufacturing a hydroxyl polymer material, comprising:
preparing a hydroxyl resin modified material;
preparing a liquid with a first auxiliary material added thereto, wherein the first auxiliary material comprises an organic polymer, silicon carbide, and aluminum oxide;
preparing an acrylic mixed reaction resin material with a second auxiliary material added thereto, wherein the second auxiliary material comprises silica, diamond powder, a ceramic particle material, and glass fiber powder;
mixing the hydroxyl resin modified material, the liquid, and the acrylic mixed reaction resin material uniformly to obtain a hydroxyl mixed reaction resin material; and
mixing the hydroxyl mixed reaction resin material and an acrylic compound resin material uniformly to obtain the hydroxyl polymer material.

2. The method for manufacturing the hydroxyl polymer material according to claim 1, wherein the liquid comprises 3-7 wt % of the organic polymer, 1.7-2.3 wt % of the silicon carbide, and 0.4-0.8 wt % of the aluminum oxide.

3. The method for manufacturing the hydroxyl polymer material according to claim 2, wherein the aluminum oxide is fine-grained aluminum oxide.

4. The method for manufacturing the hydroxyl polymer material according to claim 1, wherein the acrylic mixed reaction resin material comprises 5-10 wt % of the silica, 1-4 wt % of the diamond powder, 1.5-4.5 wt % of the ceramic particle material, and 0.5-1.5 wt % of the glass fiber powder.

5. The method for manufacturing the hydroxyl polymer material according to claim 1, wherein step of mixing the hydroxyl resin modified material, the liquid, and the acrylic mixed reaction resin material uniformly to obtain the hydroxyl mixed reaction resin material comprises:
mixing the hydroxyl resin modified material, the liquid, and the acrylic mixed reaction resin material to obtain a first mixture;
adding an adjuvant to the first mixture to undergo a chemical synthesis reaction for a preset time to obtain a first reaction mixture; and
grinding and filtering the first reaction mixture to obtain the hydroxyl mixed reaction resin material.

6. The method for manufacturing the hydroxyl polymer material according to claim 1, wherein step of mixing the hydroxyl mixed reaction resin material and the acrylic compound resin material uniformly to obtain the hydroxyl polymer material comprises:
filtering the hydroxyl mixed reaction resin material;
mixing the filtered hydroxyl mixed reaction resin material, the acrylic compound resin material, an adjuvant, and a solvent uniformly to obtain a second mixture;
leaving the second mixture to stand for a first preset time to undergo a chemical synthesis reaction to obtain a second reaction mixture; and
grinding and filtering the second reaction mixture to obtain the hydroxyl polymer material.

7. The method for manufacturing the hydroxyl polymer material according to claim 6, wherein the adjuvant comprises a curing agent, a flatting agent, an anti-settling agent, a dispersing agent, and a silver powder arrangement agent.

8. The method for manufacturing the hydroxyl polymer material according to claim 6, wherein the solvent comprises a quick drying thinner, a slow drying thinner, a strong acid thinner, a weak acid thinner, and pure water.

9. The method for manufacturing the hydroxyl polymer material according to claim 1, wherein step of preparing the hydroxyl resin modified material comprises:
providing a hydroxyl resin modified raw material;
grinding and filtering the hydroxyl resin modified raw material to obtain a hydroxyl resin modified intermediate material; and
grinding the hydroxyl resin modified intermediate material and leaving the hydroxyl resin modified intermediate material to stand for a preset time to obtain the hydroxyl resin modified material.

10. The method for manufacturing the hydroxyl polymer material according to claim 1, wherein step of preparing the first auxiliary material comprises:
mixing the organic polymer, the silicon carbide, and the aluminum oxide uniformly and filtering, to obtain a first mixed auxiliary material; and
grinding the first mixed auxiliary material to obtain the first auxiliary material.

11. The method for manufacturing the hydroxyl polymer material according to claim 1, wherein step of preparing the second auxiliary material comprises:
adding the silica, the diamond powder, the ceramic particle material, and the glass fiber powder to a solvent and mixing uniformly, to obtain a second mixed auxiliary material;
adding a dispersing agent to the second mixed auxiliary material and mixing uniformly, to obtain a third mixed auxiliary material; and
adding a silver powder arrangement agent to the third mixed auxiliary material and grinding to obtain the second auxiliary material.

12. A hydroxyl polymer material, comprising:
a hydroxyl resin modified material;
a first auxiliary material, wherein the first auxiliary material comprises an organic polymer, silicon carbide, and aluminum oxide;
a second auxiliary material, wherein the second auxiliary material comprises silica, diamond powder, a ceramic particle material, and glass fiber powder; and
an acrylic compound resin material.

13. The hydroxyl polymer material according to claim 12, wherein the hydroxyl polymer material comprises 65-70 wt % of the hydroxyl resin modified material.

14. The hydroxyl polymer material according to claim 12, wherein the aluminum oxide is fine-grained aluminum oxide.

15. The hydroxyl polymer material according to claim 12, wherein the hydroxyl polymer material comprises 10-15 wt % of the acrylic compound resin material.

16. A structural component, composed by the hydroxyl polymer material according to claim 12.
